(19) United States
(12) Patent Application Publication
(10) Pub. No.: US 2003/0064178 A1
(43) Pub. Date: Apr. 3, 2003

(54) Water-based bottle labeling adhesive

(76) Inventors: Sam Smith, Windsor (GB); Jianshe Chen, Leeds (GB); Anne Dugas, Orvault (FR)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 09/969,893

(22) Filed: Oct. 3, 2001

(51) Int. Cl. B32B 1/02

(52) U.S. Cl. 428/34.4; 428/34.1; 283/81

(57) ABSTRACT

Water-based adhesives specifically formulated for the application of transparent plastic labels onto glass substrates. The adhesive film has a clear, transparent appearance and leaves a no-label look on the bottle to which the label has been applied.

### FIELD OF THE INVENTION

The invention relates to the field of adhesives. More specifically the invention relates to aqueous adhesives useful in bonding labels to a substrate, in particular, transparent plastic labels to a glass bottle.

### BACKGROUND OF THE INVENTION

Both natural polymers and synthetic polymers have been used as base polymers in bottle labeling adhesive applications. Natural polymer-based adhesives, such as starch- and casein-based adhesives, can be formulated to offer such advantages as good machinability, high wet strength, and ice water resistance. While synthetic polymer-based adhesives provide advantages such as, for example, a fast set time, natural polymer-based adhesives are often preferred due to their safety, cost and ease of handling.

While paper labels have traditionally been used for glass bottle labeling in the food and brewery industries, an interest exist within the labeling industry to move away from traditional paper labels toward plastic labels, in particular, transparent plastic labels. One appealing benefit of using a transparent plastic label is its “no-label” appearance. Environmentally, the use of labels made of a synthetic plastic material helps to preserve natural resources by reducing the consumption of wood.

Only solvent-based adhesives have been used for the application of plastic labels to glass substrates such as bottles. A water-based adhesive capable of such use has never, heretofore, been formulated. This is due to (1) differences in surface properties of the plastic and glass substrates which makes it difficult to hold a plastic label onto a glass surface, (2) adhesive film concealed between the plastic label and glass substrate requires an extremely long time to set the label, (3) there is no where for the aqueous phase of the adhesive to go, and (4) films (either wet or dried) of many water-based adhesive are not transparent enough when applied between a plastic label and a glass substrate.

A need exists in the art for a water-based adhesive which is useful in bottle labeling applications and can advantageously be use to apply a plastic label to a glass substrate. The current invention addresses this need.

### SUMMARY OF THE INVENTION

The invention provides a water-based adhesive specifically formulated for the application of transparent plastic labels onto glass substrates. The adhesive film has a clear, transparent appearance and leaves a no-label look on the bottle to which the label has been applied.

One aspect of the invention is directed to a natural polymer-based adhesive formulation that is particularly advantageous for use in bottle labeling applications. The adhesive of the invention comprises a starch component and a gelatin/animal glue component. The starch component may desirably comprise at least two substantially different types of starch, such as both a high amylose containing starch and a starch having a high amylopectin content. Adhesives of the invention also, preferably, will contain a liquifier, a curing agent and/or a humectant or plasticizer, and may further, if desired, contain a blowing agent, a viscosity modifier, an anti-foamer and/or a preservative. Water is used as the adhesive carrier. One preferred adhesive comprises a modified waxy starch, a hydrolyzed potato starch, gelatin, zinc carbonate, urea, and dicyandiamide.

Another aspect of the invention is directed a method for bonding a first substrate to a second substrate comprising applying to a surface of at least one of said first and/or second substrate the adhesive composition of the invention. Preferably, the first substrate is a label and said second substrate is a container. Particularly preferred for use in the method of the invention are plastic labels and glass containers, such as jars, bottles and the like.

Still another aspect of the invention is directed to an article comprising a label, wherein the label is attached to the article by the adhesive described herein. A preferred embodiment of the article of the invention is a glass article comprising a plastic label, in particular, a transparent plastic label.

### DETAILED DESCRIPTION OF THE INVENTION

Various performance properties are required of an adhesive used in a high-speed labeler. Two are of particular importance, (1) adhesive strength and (2) a mechanical compatibility of the adhesive to an actually employed high-speed labeler. In applying paper labels to containers, high-speed machines (labelers) are used which transfer adhesive films, while wet, to pallets which then pick labels from label stacks and transfer the adhesive to the label. Once coated with adhesive the label is contacted with the container for permanent adhesion.

The invention provides an adhesive, a method for bonding a first substrate to a second substrate, and articles manufactured using the adhesive of the invention. A preferred method of the invention is a method for bonding a label to a container at high line speeds.

The invention provides the labeling industry with new kinds of water-based adhesives that are particularly useful for applying plastic labels onto glass containers. The adhesive has strong tack to hold the plastic label on the glass substrate and satisfactorily secures the plastic label to the glass within a reasonable time, and provides a “no-label” look due to its clarity. Moreover, the water-based adhesive of the invention may be applied using conventional high-speed labelers, in particular pallet transfer rotary labelers of the type manufactured by Krones, Ltd. This makes it possible for customers to move from traditional paper labels to plastic labels without any modification on the production line.

The adhesive of the invention comprises a starch component and a gelatin component. Preferred adhesives for use in the practice of the invention may further comprise curing agents, humectants, plasticizers, blowing agents, liquifiers, viscosity modifiers, antifoaming agents, preservatives, thickeners, salts, crosslinkers, tackifiers, filler, bleaching agents, optical brighteners, UV indicators and peptizing salts such as magnesium chloride and sodium nitrate, and/or resin emulsions to provide the required tack, overall adhesion, solution viscosity, stability, and/or desired rheological characteristics.

All starches and flours (hereinafter “starch”) may be suitable for use as the base starch. The starch material used as the starting base material may be obtained from any source. By “base” starch is meant raw, native or natural starch, i.e., starch as it comes from the plant source. Such base starch include natural starches as well as genetically altered and hybrid starches. Included are starches derived from a plant obtained by standard breeding techniques including crossbreeding, translocation, inversion, transformation or any other method of gene or chromosome engineering to include variations thereof. In addition, starches derived from a plant grown from artificial mutations and variations of the above generic composition which may be produced by known standard methods of mutation breeding are also suitable for use as the base starch herein. Typical sources for the base starches are cereals, tubers, roots, legumes and fruits. The native source can be maize (corn), pea, potato, sweet potato, banana, barley, wheat, rice, sago, amaranth, tapioca, arrowroot, canna, sorghum, and waxy or high amylose varieties thereof. A starch known in the art as waxy maize, which is a genetic hybrid, may advantageously be used in the practice of the invention. As used herein, the term “waxy” is intended to include a starch or flour containing at least about 95% by weight amylopectin and the term “high amylose” is intended to include a starch or flour containing at least about 40% by weight amylose.

Chemically modified starches may also be used as the base starch. Such chemical modifications are intended to include, without limitation, crosslinked starches, acetylated and organically esterified starches, hydroxyethylated and hydroxypropylated starches, phosphorylated and inorganically esterified starches, cationic, anionic, nonionic, and zwitterionic starches, and succinate and substituted succinate derivatives of starch. Procedures for modifying starches are well-known and described, for example in Modified Starches: Properties and Uses, Ed. Wurzburg, CRC Press, Inc., Florida (1986).

Physically modified starches may also be used as the base starch, including, without limitation, thermally inhibited or pregelatinized starches. Procedures for preparing thermally inhibited starches are disclosed, for example, in U.S. Pat. No. 6,221,420, and references disclosed therein, the disclosure of which is incorporated by reference. Exemplary processes for preparing pregelatinized granular starches are disclosed in U.S. Pat. No. 4,280,851, U.S. Pat. No. 4,465,702, U.S. Pat. No. 5,037,929, and U.S. Pat. No. 5,149,799, the disclosures of which are incorporated by reference.

The starch component may desirably comprise at least two substantially different types of starch, such as both a high amylose containing starch and a starch having a high amylopectin content. Commercially available high amylose starches which may be used in the practice of the invention include hydrolyzed potato starches such as Solvicol GP45 (available from Avebe) and Collys BR (available from Roquette). Commercially available high amylopectin containing starches which may be used in the practice of the invention include modified waxy starches such as Dexylose 1231 (available from Roquette) and Purity SCSA (available from National Starch and Chemical Company). The starch component preferable comprises from about 10 to about 50% by weight of the adhesive formulation. Preferably, the high amylopectin starch represents all or at least the major portion of the starch component, typically in the range of from about 15 to 35% of the adhesive formulation.

The term gelatin is used herein to include animal glues, bone glues, hide glues and the like. Such compounds are organic colloid polymers derived from collagen, a protein constituent of animal skins, connective tissue, and bones, principally of cattle origin. There are two general types of gelatin. Type A is derived from collagen with exclusive acid pretreatment. Type B is the result of alkaline pretreatment of the collagen. Both types of gelatin may be used in the practice of the invention. The gel-strength of the gelatin used can be from weak to high strength, but preferably medium to medium/high (typically around 200 bloom). Gelatin compounds which can be used in the practice of the invention, such as Gelatin Technical 490C are commercially available from Lijmfabriek Trobas. The gelatin component preferable comprises from about 1 to about 10% by weight of the adhesive formulation, more preferably from about 3 to about 7%.

Examples of suitable curing agents include polybasic acids and their anhydrides, polymerizable unsaturated acids, and mercaptans. Other suitable curing agents include nitrogen containing compounds and aromatic polyamines. Other useful curing agents include chloro-, bromo-, and fluoro-containing Lewis acids of aluminum, boron, antimony, and titanium, such as aluminum trichloride, aluminum tribromide, boron trifluoride, antimony pentafluoride, titanium tetrafluoride, and the like.

Liquifiers include, but are not limited to, dicyandiamide, calcium chloride and sodium nitrate. Dicyaniamide is commercially available from Asahi Denka Kogyo K. K. under the trade name Hardener 3636AS. Amounts of from about 0.5% by weight up to about 5% are typical for use in the practice of the invention.

The particular salt, when used, is not critical, and can be selected from many available salts. Nonlimiting examples include magnesium chloride, sodium chloride, sodium nitrate and ammonium acetate. The salt is typically used in amounts up to about 3% by weight. Amounts of about 0.25% to about 1.5% are preferred.

Cross-linking agents include, but are not limited to, zinc carbonate, zinc oxide and glyoxal (Ethanedial). Up to about 3% of the cross-linking agent is generally used in the practice of the invention.

The humectant used may be any of those conventionally used in formulating adhesives. Typical humectants include sugars, sorbitol, glycerin and related derivatives, urea, propylene glycol and similar related glycols and glycol ether. The humectants are used in the adhesive formulation at levels of about 1% to about 30% by weight, and typically from about 3% to about 20%, more preferably from about 5% to about 15%.

Resin emulsion may be used to provide better wet-tack. Ideally, the resin emulsion is chosen from those homopolymers or copolymers that have been dextrin-stabilized. The amount of resin emulsion used is from about 0 to about 40% by weight, typically from about 5 to about 20%. Non-limiting examples include ethylene vinyl acetate and polyvinyl acetate that are dextrin, surfactant or polyvinyl alcohol stabilized, and others that are compatible. It is noted that the choice of resin emulsion may effect the degree of clarity of the resulting adhesive.

Preservatives for use herein include those conventionally used in aqueous adhesives such as benzoates, amides and fluorides such as sodium fluoride. Also included are the hydroxybenzoic acid esters such as p-hydroxybenzoic acid methyl ester or p-hydroxybenzoic butyl ester. Commercially available preservatives which may be used in the practice of the invention include KATHON LXE sold by Rohm & Haas Compan and Nipacide OBS sold by Clariant. The preservative will generally be included in amounts of from 0.1% to about 0.2% by weight.

Adhesives of the invention generally will comprise from about 1 to about 10 parts gelatin, from about 10 to about 50 parts starch. Preferred adhesives will typically also comprise up to about 3 parts of a crosslinker such as zinc carbonate, from about 0.05 to about 1 part of an defoamer such as Belvaloid, from about 1 to 30 parts of a humectant such as urea, from about 0.5 to about 5 parts of a liquifier such as dicyandiamide, and water to make up to 100 parts. When a combination of a high amylose starch and high amylopectin starch is used, the major portion is preferably the high amylopectin portion of the starch component.

Generally, the adhesives of the invention may be made by mixing the components as described in further detail in the Examples. The order of addition is not critical. Cooking temperatures will generally be greater that 70° C., typically up to about 95° C. for periods of up to about 90 minutes or longer. The viscosity of the product is then adjusted e.g. through addition of extra water, liquifier (e.g. dicyanoamide) and/or humectant (e.g. urea) to lower the viscosity to the preferred range of between about 40,000 cps up to about 150,0000 cps, preferably between about 70,000 cps and 120,000 cps.

While the adhesive finds particular use as a labeling adhesive, other uses are clearly contemplated and are encompassed by the invention. The adhesive described herein may be used to for, e.g., laminating, in particular, where two substrates require bonding and the resultant bond should have a clear appearance.

As used herein, a “container” means a jar, bottle, can or canister, bucket, beaker and the like. The container may be made of glass, plastic or metal. Specific examples include, but are not limited to soft drink bottles, beer bottles, wine bottles, salad dressing bottles, sauce jars, condiment jars, and the like. The container may be made of any type of material including but not limited to wood, glass, metal, plastic or poly and plastic-coated glass.

As used herein and a “label” means e.g. a material having a surface to which an adhesive is applied. The label may be made of any type of material, including but not limited to paper, plastic or metallized paper and the like. Labels may be of any size or shape. While the label may be opaque, a preferred embodiment is transparent plastic labels.

Use of the adhesives of the invention to bond plastic labels to glass substrates is particularly advantageous. A preferred embodiment of the invention is the use of the adhesives of the invention to bond transparent plastic labels to glass substrates.

By “transparent” means that at least a portion of the label is substantially clear, i.e., the surface of the substrate to which the label has been applied is visible through the label and adhesive.

Plastic as used herein refers to the material used to make e.g., food and other storage containers and/or labels include polyethylene, polypropylene, polystyrene, polycarbonate, polyvinylchloride, high density polyethylene (HDPE) and polyethylene terephthalate (PET).

To attach the labels to the article, the adhesive is applied to the surface of the container or, when using a high speed labeler, directly to the label. The label and the article are then contacted under pressure and the adhesive bond allowed to set. The amount of pressure and the time need to set the bond will depend upon the type of container, label, and the particular adhesive formulation used.

The following examples are for purpose of illustration and not intended to limit the scope of the invention in any manner.

### EXAMPLES

### Example 1

52% water, 0.2% defoamer, 0.9% zinc carbonate and 12% urea were mixed (e.g. in a vessel with a rotating agitator) until homogeneous, after which 7.8% Collys Br and 23.5% Dexylose I 231 were added. The mixture was then heated to 72° C. and held at this temperature for 20 mins. The mixture was then cooled to 65° C. and 0.6% ammonium acetate added. 3% Bone glue was then added between 60 and 65° C. and the final mixture cooled to room temperature.

### Example 2

47% water, 0.2% defoamer, 0.9% zinc carbonate and 15% urea were mixed (e.g. in a vessel with a rotating agitator) until homogeneous, after which 5% gelatine was added, followed by 7.8% Solvicol GP45 and 23.5% Dexylose I 231. The mixture was then heated to 72° C. and held at this temperature for 20 mins. The mixture was then cooled to 65° C. and 0.6% ammonium acetate added, and the final mixture cooled to room temperature.

### Example 3

47% water, 0.2% defoamer, 0.9% zinc carbonate and 15% urea were mixed (e.g. in a vessel with a rotating agitator) until homogeneous, after which 5% gelatin was added, followed by 7.8% Solvicol GP45 and 23.5% Dexylose I 231. The mixture was then heated to 80° C. and held at this temperature for 90 mins. The mixture was then cooled to 65° C. and 0.6% ammonium acetate added, and the final mixture cooled to room temperature.

### Example 4

53% water, 0.2% defoamer, 0.9% zinc carbonate and 7% urea were mixed (e.g. in a vessel with a rotating agitator) until homogeneous, after which 2% dicyandiamide added and the mix stirred, 5% gelatine was then added, followed by 7.8% Solvicol GP45 and 23.5% Dexylose I 231. The mixture was then heated to 80° C. and held at this temperature for 60 mins. The mixture was then cooled to 65° C. and 0.6% ammonium acetate added, and the final mixture cooled to room temperature.

### Example 5

The viscosity of the adhesive mixtures prepared in Examples 1-4 were adjusted by the addition of urea and/or water, or the like to a desired viscosity. The adhesive samples were coated onto a transparent plastic label. The label was then applied to a glass jar and allowed to dry. The adhesive exhibited good wet tack. Dried adhesive was substantially clear, with the glass substrate visible through the dried adhesive.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. An adhesive comprising a starch component, a gelatin component and water, said adhesive being substantially clear when dried.

2. The adhesive of claim 1 wherein the starch component comprises at least two substantially different types of starches.

3. The adhesive of claim 2 wherein the starch component comprises a high amylose starch and a high amylopectin starch.

4. The adhesive of claim 1 further comprising a crosslinking agent, a liquifier and a humectant.

5. The adhesive of claim 4 which further comprises urea, dicyandiamide and zinc carbonate.

6. A method for bonding a first substrate to a second substrate comprising applying to a surface of at least one of said first and/or second substrate the adhesive composition of claim 1.

7. The method of claim 6 wherein said first substrate is a label and said second substrate is a container.

8. The method of claim 7 wherein the adhesive is applied to a surface of the label.

9. The method of claim 8 wherein said label is made of plastic and said container is a bottle or jar.

10. The method of claim 9 wherein at least a portion of said plastic label is transparent.

11. The method of claim 9 wherein said bottle or jar is made of glass.

12. The method of claim 9 wherein the plastic is selected from the group consisting of polyethylene, polypropylene, polystyrene, polycarbonate, and polyvinylchloride.

13. An article comprising a label, wherein the label is attached to the article by the adhesive of claim 1.

14. The article of claim 13 which is a container.

15. The article of claim 13 wherein the container is a glass container

16. The article of claim 13 wherein the label is a plastic label.

17. The article of claim 16 wherein at least a portion of said plastic label is transparent.
